(19) United States
(12) Patent Application Publication
(10) Pub. No.: US 2023/0141016 A1
(43) Pub. Date: May 11, 2023

(54) SYSTEM AND METHOD OF DIRECTED ENERGY DEPOSITION USING A SOUND FIELD

(71) Applicants: Alejandro MARTINEZ, Waterloo (CA); Ehsan TOYSERKANI, Waterloo (CA)

(72) Inventors: Alejandro MARTINEZ, Waterloo (CA); Ehsan TOYSERKANI, Waterloo (CA)

(21) Appl. No.: 17/911,832

(22) PCT Filed: Mar. 18, 2021
(86) PCT No.: PCT/CA2021/050358

§ 371 Date: Sep. 15, 2022

Related U.S. Application Data
(60) Provisional application No. 62/991,299, filed on Mar. 18, 2020.

(51) Int. Cl. B29C 64/321; B29C 64/153; B29C 64/268; B29C 64/209; B29C 64/371

(52) U.S. Cl. CPC B29C 64/321; B29C 64/153; B29C 64/268; B29C 64/209; B29C 64/371; B33Y 30/00

(57) ABSTRACT

A directed energy deposition system and method including a set of nozzles for directing material, such in the form of a particle stream, at a part and a set of energy sources for generating a melt pool as the material contacts the part. The system further includes apparatus for generating a sound field that controls characteristics of the particle stream as it passes through the sound field.

### CROSS-REFERENCE TO OTHER APPLICATIONS

The disclosure claims priority from U.S. Provisional Application No. 62/991,299 filed Mar. 18, 2020, the contents of which are hereby incorporated by reference.

### FIELD

The present disclosure relates generally to directed energy deposition, a class of additive manufacturing technology, and, more specifically, to a system and method of directed energy deposition using a sound field.

### BACKGROUND

In the field of advanced manufacturing, and in particular additive manufacturing, the building and repair of components or parts is a well-known process. One method that is used in the building/repairing of parts is via directed energy deposition. In this approach, the part is made or repaired by depositing material on the surface of the part being built/repaired. The material being deposited can be in the form of a powder or wire. As the material is being deposited, energy is added locally to the newly deposited material to melt it and attach it to the part being built/repaired.

There have been different directed energy deposition approaches that have been used in the past. U.S. Pat. No. 9,908,288B2 describes a part being fabricated by an additive manufacturing process while levitating in space. The features of the part are formed by additive manufacturing. The part levitation system allows the spatial orientation of the part to be manipulated relative to one or more material deposition subsystems (print heads). US Patent Publication No. 2016/0228991A1 describes a method and system of generating at least one ultrasonic standing wave between at least one set of opposing ultrasonic transducers. Metal-containing particles are deposited on a node located within the ultrasonic standing wave such that the particles are trapped in the node, positioning a surface of a substrate close to the node, melting the particles with an energy beam to form a melt pool in contact with the surface, and allowing the melt pool to cool and solidify into a metal deposit bound to the surface. US Patent Publication No. 2016/0318129A1 describes a system and method for the additive manufacturing of an object using multiple lasers. The system includes a first laser generating a first focused laser beam having a first surface area where the first focused laser beam is directed onto a first quantity of a powder material on a substrate to fuse particles of the powder material in a first layer of the substrate. A second laser generating a second focused laser beam having a second surface area where the second laser beam is directed onto a second quantity of the powder material on the substrate to fuse particles of the powder material in the first layer of the substrate. The first surface area of the first focused laser beam is greater than the second surface area of the second focused laser beam. However, each of these prior art solutions has disadvantages.

Therefore, herein is provided a novel method and system for directed energy deposition.

### SUMMARY

The disclosure is directed at a system and method of directed energy deposition using a sound field. In one embodiment, the sound field changes the characteristics of a particle stream as it passes through the sound field. Characteristics include, but are not limited to, the cross-sectional size (spatial focusing) of the particle stream, the shape of the particle stream, and the path of the particle, or powder, stream.

In one aspect of the disclosure, there is provided a method of directed energy deposition including generating a sound field; passing a particle stream through or by the sound field towards a part being fabricated; and melting the particle stream as it contacts the part being fabricated; wherein the sound field controls at least one characteristic of the particle stream as it passes through the sound field and contacts the part being fabricated.

In another aspect, the method further includes, before generating a sound field, generating the particle stream. In a further aspect, generating the particle stream includes transporting material from a material feed system to a material nozzle; and directing the material into the particle stream towards the part being fabricated. In yet another aspect, transporting material from the material feed system to the material nozzle is via a pressurized gas system.

In yet another aspect, generating a sound field includes determining desired characteristics of the particle stream; calculating the sound field required to achieve the desired characteristics; and transmitting signals to sound sources to generate the sound field. In an aspect, calculating the sound field includes calculating the sound field using an iterative backpropagation methodology, analytic phase hologram solutions, or numerical optimization of signal amplitude and/or phases of sound sources. In a further aspect, calculating the sound field using an iterative backpropagation methodology includes calculating the sound field using a Gor′kov methodology.

In another aspect, generating the sound field includes generating at least one sound period averaged pressure intensity isosurface. In a further aspect, the method further includes coating the particle stream with a gaseous or liquid medium before passing the particle stream through of by the sound field. In yet another aspect, the at least one characteristic includes a particle stream cross-sectional particle concentration distribution; a cross-sectional size of the particle stream; a shape of the particle stream or a path of the particle stream.

In another aspect of the disclosure, there is provided a system for directed energy deposition including at least one nozzle for directing a particle stream at a part; at least one energy source for melting the particle stream; and at least one sound source for generating a sound field which the particle stream passes through, the sound field controlling characteristics of the particle stream before it contacts the part.

In a further aspect, the system further includes a processor for calculating and generating the sound field. In yet another aspect, the system further includes at least one sound field modification component for generating the sound field. In another aspect, the system further includes a material feed system for supplying material, in the form of the particle stream, to and through the at least one nozzle. In another aspect, the material may be one of a metal, a metal alloy, a metal filler, a metal-containing flux material, a dopant, a ceramic, a composite, a polymer or any combination thereof.

In yet a further aspect, generating a sound field includes generating isosurfaces for controlling the particle stream as the particle stream passes through or by the isosurfaces.

### BRIEF DESCRIPTION OF THE DRAWINGS

Embodiments of the present disclosure will now be described, by way of example only, with reference to the attached Figures.

FIG. 1a is a perspective view of a first embodiment of apparatus for directed energy deposition;

FIG. 1b is a perspective view of a second embodiment of an apparatus for directed energy deposition;

FIG. 2 is a front view of a directed energy deposition system with a coaxial laser arrangement;

FIG. 3 is a front view of a directed energy deposition system with a side powder feed arrangement;

FIG. 4 is a front view of a directed energy deposition system with a coaxial powder feed arrangment;

FIG. 5 is a side view of a directed energy deposition system mounted to a robot arm;

FIG. 6 are enlarged views of material being deposited on a part using a directed energy deposition system in accordance with the disclosure;

FIG. 7 is a perspective view of how a particle stream is deflected before contacting a build plate;

FIG. 8 are perspective views of how a cross-section of the particle stream is changed prior to contact with the build plate;

FIG. 9 is a perspective view of yet another embodiment of a directed energy deposition system;

FIG. 10 is a flowchart outlining a method of directed energy deposition; and

FIG. 11 is a flowchart outlining a method of determining a sound field for use in the method of FIG. 10.

### DETAILED DESCRIPTION

The disclosure is directed at a method and system for directed energy deposition. In one embodiment, the system of the disclosure includes at least one nozzle for directing material (such as in the form of a particle stream) towards a part and at least one energy source for melting the material to form a melt pool. In one embodiment, energy source melts the particle stream as it comes into contact with the part. The system further includes a set of sound generating components that generate a sound field which the particle stream passes through, the sound field affecting certain characteristics of the particle stream to control the certain characteristics of the particle stream.

In a directed energy deposition process, as material and energy are added to the part or component, certain characteristics of the part, such as, but not limited to, the part geometry, surface roughness and material properties such as mechanical properties and microstructure, may be affected or controlled by the melt pool. The part geometry and roughness may be determined by the resolution of the directed energy deposition system, which depends on the size of the melt pool. The mechanical properties and microstructure of the part depend on the changes in cooling rates between the material being deposited and the rest of the part which is partially affected by the shape of the melt pool.

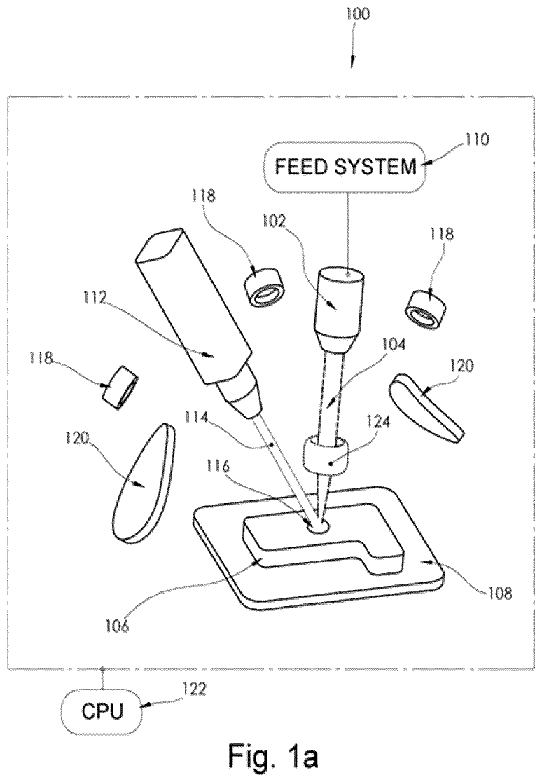

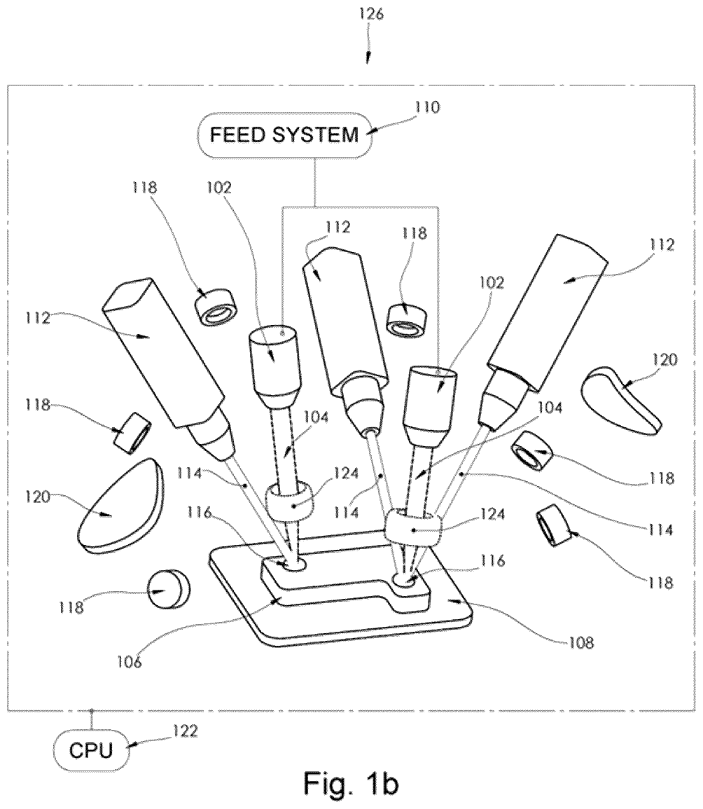

Turning to FIG. 1a, a perspective view of a system for directed energy deposition is shown. The system 100 includes at least one nozzle 102 for supplying or directing material (such as in the form of particle stream 104) towards a part 106 being fabricated. Alternatively, instead of being fabricated, the part may be being repaired by the directed energy deposition. In the current embodiment, the part being fabricated rests atop a build plate 108. Depending on the design of the directed energy deposition system, the build plate 108 may be permanently fixed with respect to the nozzle or may include control elements whereby the position of the build plate 108 may be moved with respect to the nozzle such that the position of the part 106 can be moved during directed energy deposition.

The at least one nozzle 102 is connected to a material feed system 110, which provides the particles or material that is directed at the part 106 by the nozzle 102. In other words, the material feed system supplies the material needed to fabricate or repair the part 106. In one embodiment, the material may be in the form of a powder, wire or material particles. The powder may be a polymer, metal, metal alloy, metal filler, metal-containing flux material, dopant, ceramic, or composite material or any suitable element or any combination thereof.

In one embodiment, the material particles are accelerated by the material feed system 110 to and through the nozzle 102 using a gas flow and/or gravitational force, although other methods of transmitting or transporting the material from the material feed system 110 to the nozzle 102 are contemplated. In this embodiment, the part resolution and surface roughness may be controlled or determined by the nozzle design and dimensions. The material feed system 110 may further provide a shielding gas that surrounds the particle stream to assist in particle or particle stream focusing and to reduce the likelihood or prevent chemical reactions between the particle stream (or powder) and atmosphere. In one embodiment, this produces a particle stream with a fixed distance and direction from the nozzle to a location of low, or minimum particle stream cross-section width (particle focus point) and a fixed particle stream cross-section shape. The cross-sectional size and shape of the particle stream refer to a cross-sectional shape of the particle stream, normal to the particle stream path. In some embodiments, the cross-sectional shape may be defined with respect to the powder concentration distribution which may be described by a Gaussian function that has an infinite extent whereby the cross-section may be defined the radius of the particle stream where a threshold value is chosen to drop the edges of the powder concentration distribution function. As discussed below, due to interaction with a sound field, the cross-sectional particle concentration distribution and its corresponding cross-sectional size and shape at some particular particle concentration threshold value can be adjusted.

The system 100 further includes energy sources 112 that supply energy beams 114 to melt the material when it contacts the part 106, in the form of melt pools 116. The term ‘energy beam’ used in this disclosure is used in a general sense to describe a narrow, propagating stream of energy particles and/or packets of energy which may include a light beam, a laser beam, an electron beam, a particle beam, a charged-particle beam, a molecular beam, etc., which upon contact with a material imparts kinetic (thermal) energy to the material. These melt pools 116, at different times within the part build, or directed energy deposition process, may be stationary or moving with respect to the part 106.

As can be seen in FIG. 1a, the system 100 further includes a set of sound sources 118, such as, but not limited to, transducers, that generate a sound field which the particle stream 104 passes through. In some embodiments, the system may also include sound field modification components 120, which may be seen as deflectors, which may further assist in generating the required sound field. A sound field modification component may refer to any component that may reflect or refract sound waves or any combination thereof. Sound field modification components may be used to decrease the number of sound sources needed and/or their power consumption. The sound field modification components may also decrease the sound level exposure to an operator outside the directed energy deposition system. The system may further include a central processing unit (CPU) 122 for controlling the components of the system. For instance, the CPU may calculate the sound field that needs to be generated to control the particle stream and may then transmit signals to the sound sources 118 to generate the calculated sound field. The CPU 122 may also control operation of the energy sources 112 and the material nozzles 102 to open and/or close the nozzles, when required. The CPU 122 may also control the build plate 108 to move the plate 108 with respect to the nozzle 102. The CPU 122 may also control a position of the sound producing components (the sound sources and/or the sound field modification components) whereby they may be actuated to move with respect to the other, generally stationary, components. In one embodiment, the sound sources may be fed a signal from a digital and/or analog signal generator, or any combination thereof, instead of the CPU 122, pre-set to generate a sound, having specific or pre-determined characteristics.

As the particle stream 104 (or streams such as in FIG. 1b) pass through the sound field or pass through or by an isosurface generated by the sound field, the characteristics of the particle stream may be controlled. For example, the particle stream may be spatially modified to have a desired, or predetermined, cross-sectional area and shape such that these characteristics of the particle stream can be controlled by the sound field, which produce sound radiation forces, immediately before the particle stream reaches the part 106 so that the melt pool is created. For example, as shown in FIG. 1a, the sound field generated by the sound sources 118, and the sound field modification components 120, if present, may produce sound period averaged pressure intensity isosurfaces 124 with the example shapes as schematically shown. It will be understood that the isosurfaces are not physical components but a representative subset of the sound field that is generated.

The use herein of the term ‘sound period averaged pressure intensity isosurface,’ or any reference to isosurface or isosurfaces refers to the three-dimensional (3D) surface or surfaces formed by points of a constant value within a volume of space, where the value being considered herein is the averaged instantaneous acoustic pressure of the sound field over a period of time equal to the sound wave's period in the sound field. Acoustic pressure may be seen as the local pressure deviation from the ambient (average or equilibrium) atmospheric pressure caused by a sound field. The amount of time used to calculate this averaging may be different than the sound wave's period, for example when using two or more sound fields in a sequence that are then repeated in time, in which case the time used for the averaging will be the repetition time. The description of the sound fields in terms of these isosurfaces aids in the understanding and design of the directed energy deposition system described herein. In some embodiments, the sound period averaged pressure intensity isosurfaces may have values that may range from 2 to 20 kPa (kilopascals).

As taught below, along with controlling the characteristics of the particle stream, right before it contacts the part 106, a path of the particle streams 104 from the nozzle 102 to the melt pools 116 may also be modified or controlled by the sound field.

Although only a single particle stream (and nozzle) is shown with respect to FIG. 1a, the material may be provided using one or more material feed systems and nozzles (providing a corresponding number of particle streams) or any combination thereof such as schematically shown in FIG. 1b. With multiple material feed systems and multiple nozzles, multiple melt pools may be enabled. Alternatively, there may be a single material feed system connected to multiple nozzles. The selection and design of the material feed system and nozzle combinations may be based on the required materials for the part manufacture or repair. The system 126 may be controlled by the CPU 122.

The sound sources 118 and energy sources 112 (resulting in motion of the energy beams 114) may move and rotate in space while manufacturing the part 106 in order to more accurately control or shape the particle stream.

As is understood, different laser and nozzle/powder stream arrangements produce different particle stream/sound force field interactions, and therefore, different positioning of the sound sources, the energy sources, and particle stream nozzles are contemplated that are not all disclosed or shown in the disclosure.

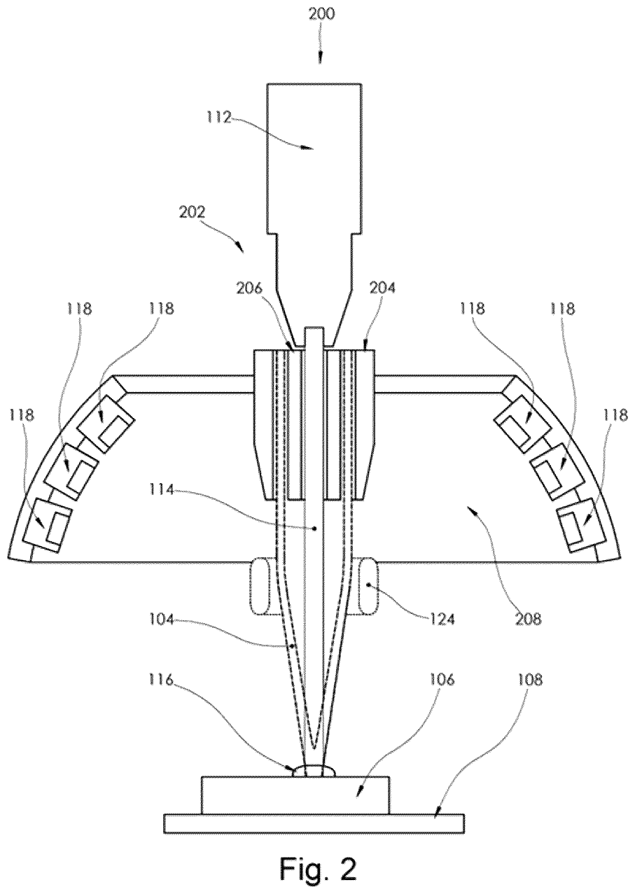

Turning to FIG. 2, a front view of another embodiment of a directed energy deposition system is shown. Certain components from the embodiment of FIG. 1a are also used in the embodiment of FIG. 2. As shown, the system 200 includes an integrated nozzle 202 that has a material, or powder, nozzle portion 204, and an energy nozzle portion 206. The material nozzle portion 204 is connected to a material feed system and delivers the material, while the energy nozzle portion 206, connected to an energy source 112, delivers the energy for melting the material as it contacts the part 106. The system 200 further includes a frame portion 208 to which the integrated nozzle 202 may be mounted along with a set of sound sources 118. In the current embodiment, the frame portion 208 has a spherical zone shape, however, it will be understood that the shape of the frame portion may be designed according to the desired characteristics of the controlled particle stream whereby the frame portion 208 may provide for the positioning of the sound sources with respect to the desired particle stream characteristics being controlled. Also, while six sound sources 118 are shown, it will be understood that any number of sound sources may be mounted to the frame portion 208. Although not shown, if there are sound field modification components, they may also be mounted to the frame portion 208. In some embodiments, the frame may also act as a sound field modification component.

In this embodiment, by strategically positioning the sound sources, the sound field may be focused. When the sound field is focused, the intensity of the sound field changes and the amplitude increases. The time averaged sound intensity (amplitude value) pressure, when it is focused at one point, generates the isosurface and as the particle stream passes by or through the isosurface (depending on the shape of the isosurface), the particles repel from the isosurface. This property of the relationship between the particle stream and the sound field allows a changing of the isosurface shape, in real-time, to change or control the characteristics of the particle stream as it passes through the sound field, which contains isosurfaces. For example, by generating an “isosurface wall” in the path between the nozzle and the part, the particle stream may be re-directed in another direction. Alternatively, a hollow cylinder isosurface may be generated that causes the particle stream to narrow as is passes through the isosurface.

As can be seen in FIG. 2, the energy source 112 is connected to the integrated nozzle 202 and, in the current embodiment, supplies a coaxial energy beam 114 from the energy source 112 to melt the particle stream 104 supplied by the material, or powder nozzle portion 204. In use, the particle stream 104 is spatially modified by the sound field (which produces the sound period averaged pressure intensity isosurface 124) generated or created by the set of sound sources 118. The spatially modified particle stream 104 reaches the melt pool 116 and adds material to the part 106 with the characteristics of the particle stream being controlled by the sound field. When the particle stream contacts the part 106 at the melt pool 116 location, the energy beam 114 melts the material and the part, thereby creating the melt pool 116.

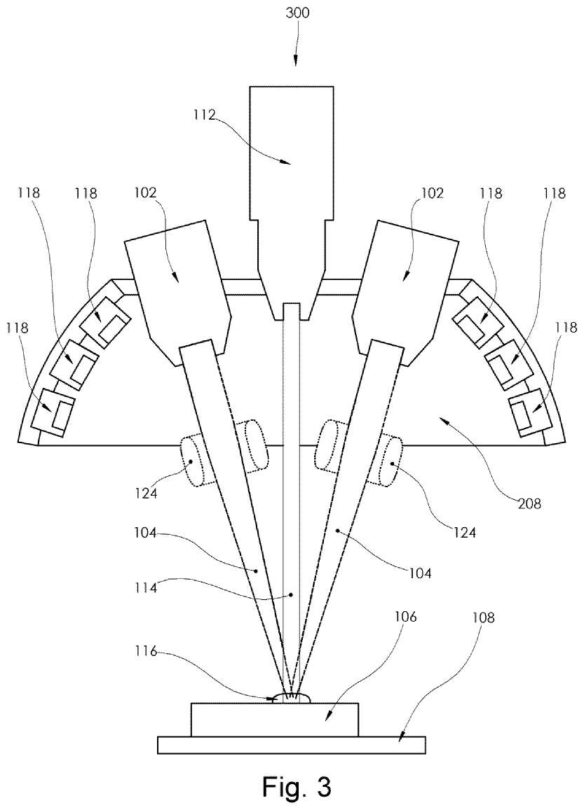

Another example embodiment of a directed energy deposition system is shown in FIG. 3. In this embodiment, the system 300 includes a set of material nozzles 102 that are mounted to a frame portion 208. As with the embodiment of FIG. 2, a set of sound sources 118 are mounted to the frame portion 208 to generate the sound field which the particle streams 104 pass through.

In use, the particle streams pass through the sound field (and through or by sound period averaged pressure intensity isosurfaces 124) and contact the part 106 at the same melt pool location whereby the energy beam 114 from a single energy source 112 creates a melt pool 116 between the two particle streams and the part 106 to add the material from the two particle streams to the part 106.

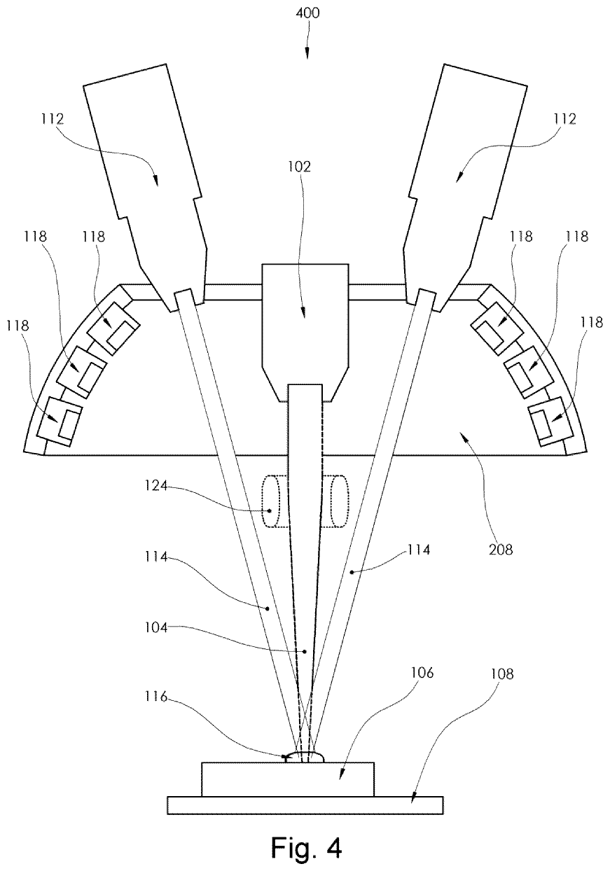

Another embodiment of a directed energy deposition system is shown in FIG. 4. In the embodiment of FIG. 4, the system 400 includes two energy sources 112 and a single material nozzle 102 whereby there are two energy beams 114 that melt the particle stream 104 as it contacts the part 106. In this example, more than one energy source 112 produces energy beams 114 that heats the melt pool 116 while a single nozzle 102 provides the particle stream 104 that is being modified or controlled by a sound field with an example sound period averaged pressure intensity isosurface 124.

As seen from the above embodiments, the number of energy sources and energy beams, the number of nozzles producing particle streams and the number of sound sources can vary in the directed energy deposition system and may be selected based on the desired application of the directed energy deposition system or a desired number of melt pools or based on the characteristics of the particle stream that are desired to be controlled.

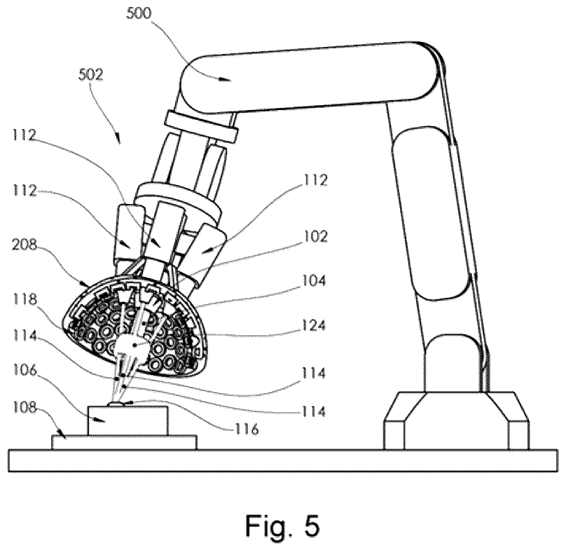

Turning to FIG. 5, a further embodiment of a system for providing directed energy deposition is shown. As shown in FIG. 5, the directed energy disposition system (such as the ones discussed above) is integrated with, or may include, a robot, or robotic, arm 500. In this example, the set of energy sources, material nozzle, or nozzles, and frame portion holding the sound sources and/or sound components may be seen as an end effector 502 of the robot arm. In the current embodiment, the end effector 502 is the same as the system of FIG. 4.

In operation, the robot arm 500 may control the position of the components of the end effector 502 of the directed energy deposition system. This may be done as a single control where all of the components of the end effector move together or the components (seen as the material nozzle or nozzles, the sound sources, the build plate, the energy sources and the like) may be individually controlled by the robot arm 500.

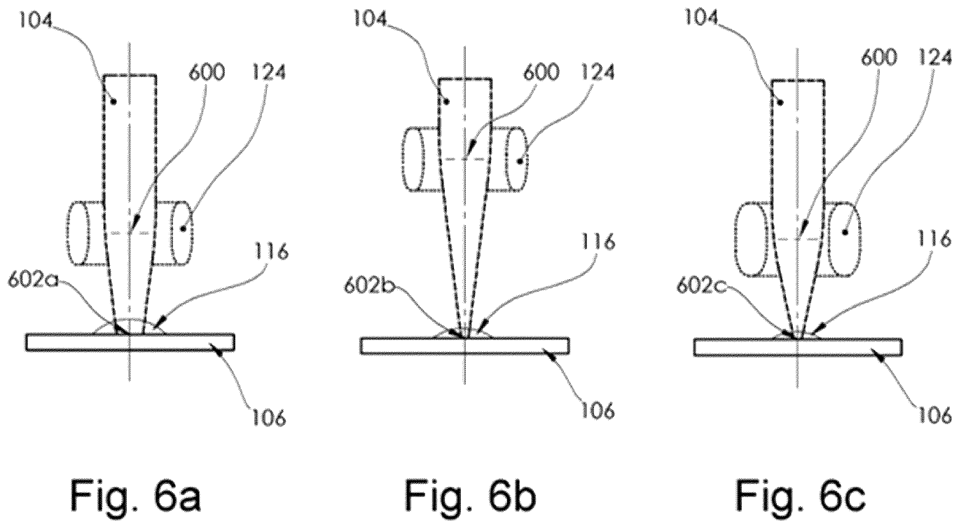

For FIGS. 6 to 8, when the part 106 is being referenced, it is understood that it might also refer to the build plate 108, such as when the additive manufacturing process is starting.

Turning to FIGS. 6a to 6c, a set of diagrams showing a particle stream passing through a sound period averaged pressure intensity isosurface 124 is shown. With respect to these Figures, the area where the particle stream passes through the isosurface may be seen as a sound field focus point 600. As can be seen, depending on where the particle stream passes the isosurface (or sound field) with respect to the part 106, the size of the cross-section of the particle stream that contacts the part 106 can be controlled.

Using FIG. 6a as the neutral or base position, it can be seen that as the particle stream 104 passes through the isosurface 124, the particle stream contacts the part with a cross-section 602a. For explanation purposes, it is assumed that the intensity of the sound field in FIG. 6a is at a base level.

As shown in FIG. 6b, if the isosurface 124 (or focused sound field) is moved away from the part 106, it can be seen that the cross-section of the particle stream can be controlled. As can be seen in FIG. 6b, a degree of particle focusing may be controlled by the position of the sound focus point 600 whereby the cross-section 602b of the particle stream that contacts the part is smaller than the cross-section of the particle stream when it passes through the isosurface. In operation, the particles repel away from the isosurface 124 as the particle stream 104 passes through the isosurface 124.

As shown in FIG. 6c, if the intensity of the sound is increased (with respect to the base level of FIG. 6a) at the isosurface 124, the cross-section of the particle stream 104 may be controlled by the sound field intensity. As shown in FIG. 6c, a location of the isosurface with respect to the part 106 is the same as the isosurface of FIG. 6a, however, with an increase in the intensity of the sound field, the cross-section 602c of the particle stream that contacts the part 106 is more directed and focused. The higher level of intensity of the sound field, the more repelling force that is applied to the particle stream. In some embodiments, the cross-section of the particle stream that contacts the part is smaller than the cross-section of the particle stream before it passes through the sound field, although in some embodiments, the characteristics of the particle stream may be controlled such that the cross-section that contacts the part is larger than the initial particle stream cross-section.

In FIGS. 6a to 6c, the particle stream 104 moving downwards hits the part 106 at the particle focus point at the center of cross-sections 602a to 602c that has been modified by the sound field with a sound period averaged pressure intensity isosurface 124. The particle focus point at the center of cross-sections 602a to 602c is usually required to be at the location where the material is being added to the part 106 being fabricated.

While FIGS. 6a to 6c show a sound focus point for the sound field, in some embodiments, there may not be a sound focus point. The use of the term sound focus point aids in the design of a sound field that is designed or generated by an array of sound sources. For example, using the frame portion (which may have a spherical zone or parabolic shape of FIGS. 2 to 4, the arrangement of the sound sources may produce a larger degree of focusing for the same sound source power consumption. This may be referred to as a sphere zone arrangement. In these embodiments using the array of sound sources in the form of a sphere zone arrangement, the sound field (assuming the same input signals going to each sound source) produces its highest average pressure intensity at close to the center of the sphere zone which may be seen as the sound focus point. One can then modify the input signals to any or each of the sound sources such as their phase, in order to generate the required sound field to affect the particle stream. It is understood that other sound source positions and orientations are contemplated that do not have a sound focus point and/or might have disconnected sound period averaged pressure isosurfaces.

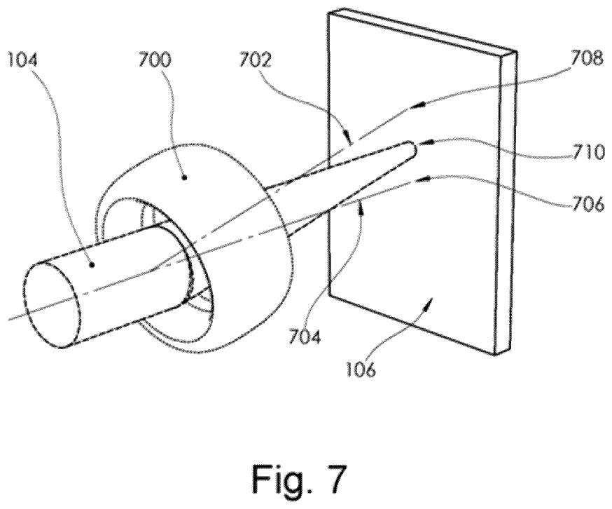

As schematically shown in FIG. 7, the path of the particle stream 104 may be changed by applying a vortex sound field with a sound period averaged pressure intensity isosurface 700 that has an axis of symmetry 702 that is not congruent with the axis 704 of the particle stream 104. In this example, the intersection of the particle stream original axis and the part 106 given by point 706 is not congruent with the intersection point 708 of the vortex sound field symmetry axis 702 and the part 106, producing a particle focus point 710 that is offset from the initial particle stream axis 704. In other words, in the absence of the sound field, the particle stream should contact the plate at point 706, however, the presence of the isosurface (in the form of the vortex sound field) re-directs the particle stream so that it contacts the part at point 710. While not shown, it is understood that a melt pool is formed by applying energy to the particle stream as it contacts the part.

In one embodiment, to determine the input signals needed to be applied to the sound sources to achieve the required sound field, the calculations may be performed by numerically minimizing the weighted period averaged sound intensity at a desired spatial point minus the axis component weighted Laplacian of the Gor′kov potential of a sound field that will give different sound fields that may produce a sound radiation field pointing towards the desired spatial point from any direction. The negative of gradient of the Gor′kov potential yields the sound radiation force. The variables that are required for this optimization problem are the phases of the sound sources, which are used to compute the Gor′kov potential via a numerical and/or analytic model of the sound fields for each sound source which depends on the sound source phases. By adjusting the weights of each component of the Laplacian and the weight in front of the period averaged sound intensity, one can obtain different useful sound fields such as a vortex sound field which for acoustic levitation is referred to as a vortex trap.

In another embodiment, some analytic solutions for signals for the sound sources to generate a required sound field may be used, such as, but not limited to, vortex sound fields with different topological charges. This sound field may be required to have wider vortex sound field isosurface, for example, the isosurface 124 shown in FIG. 2. An example of the use of this analytic solution is described in A. Marzo, M. Caleap, and B. W. Drinkwater, “Acoustic Virtual Vortices with Tunable Orbital Angular Momentum for Trapping of Mie Particles,” Phys. Rev. Lett., vol. 120, no. 4, p. 044301, January 2018, doi: 10.1103/PhysRevLett.120.044301.

In another embodiment, another method of calculating the input signals for the sound sources to generate the desired sound field or sound fields may be performed by using an iterative backpropagation methodology or algorithm to find the phases of the sound sources. This methodology may be used to find the required sound source phases when designing holographic acoustic tweezers. This methodology uses a modified version of the iterative angular spectrum approach, which is based on the Gerchberg-Saxton algorithm used to generate holographic optical tweezers. An example of this iterative backpropagation algorithm being applied to levitate multiple particles is disclosed in A. Marzo and B. W. Drinkwater, “Holographic acoustic tweezers,” PNAS, vol. 116, no. 1, pp. 84-89, January 2019, doi: 10.1073/pnas.1813047115.

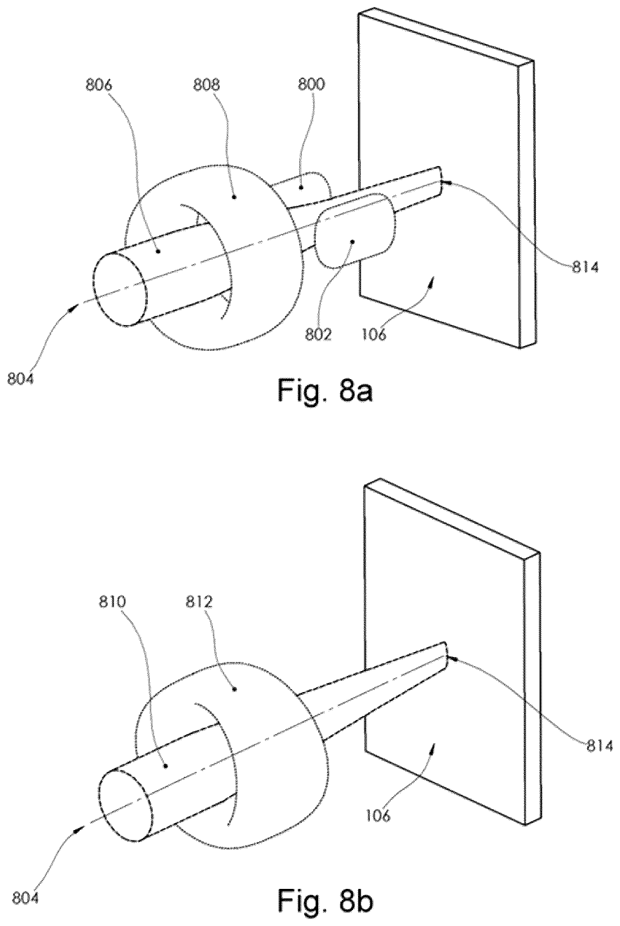

Turning to FIGS. 8a and 8b, schematic diagrams showing particles streams contacting parts are shown. More specifically, FIGS. 8a and 8b illustrate examples how a sound field can control the particle stream to change the cross-section of the particle stream to a non-circular cross-section, such as, but not limited to an approximately elliptical cross-section, that contacts the part.

In the current embodiment, this may be achieved by using the sound sources to generate a pair of disconnected sound period averaged pressure intensity isosurfaces 800 and 802 with two different sound focus points along an axis 804 of a particle stream 806 (FIG. 8a). The particle stream may initially also go through an isosurface 808, in order to increase the amount of focusing. In another embodiment, this may be achieved by rapidly switching between two or more sound fields for different fractions of a time repetition period as a particle stream 810 passes the sound field, producing an example repetition period averaged pressure intensity isosurface 812 (FIG. 8b). Although particle streams 806 and 810 may initially be shaped differently (or have different cross-sections), the resulting cross-section for both particle streams that contact the part may be the same, for instance, an elliptical cross-section at the particle focus point 814. An example of this method being used to levitate and independently adjust the rotational speed of a large particle is described in A. Marzo, M. Caleap, and B. W. Drinkwater, “Acoustic Virtual Vortices with Tunable Orbital Angular Momentum for Trapping of Mie Particles,” Phys. Rev. Lett., vol. 120, no. 4, p. 044301, January 2018, doi: 10.1103/PhysRevLett.120.044301.

When using this switching method, similar to pulse width modulation in electric motor control, the sound fields can have different or equal sound focus point locations. Sound fields that could be used are a vortex and a twin sound field, for example. The twin sound field produces approximately two cylindrical isosurfaces of sound period averaged pressure intensity 800 and 802 that focus particles along only one direction perpendicular to the particle stream axis. Any combination thereof of the previously described techniques applicable to the sound sources may be combined to focus, move sideways and change the particle focus cross-sectional size and shape or any combination thereof at the same time.

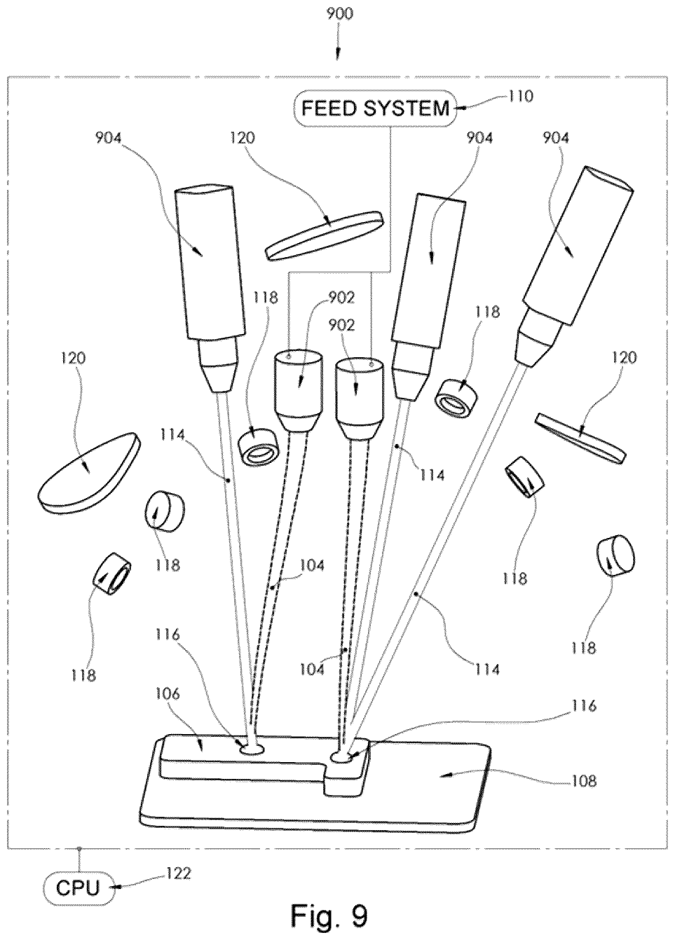

Another embodiment of a directed energy deposition system is shown in FIG. 9. The system 900 includes a set of material nozzles 902 that deliver or direct separate particle streams 104 of material towards a part 106 being repaired or fabricated located on a build plate 108. The system 900 further includes a set of energy sources 904 that direct energy towards the part 106 to melt the particle streams as they contact the part 106, thereby creating a melt pool 116. The system 900 further includes a set of sound sources 118 and sound field modification components 120.

In the current embodiment, the set of material nozzles 902 are stationary with respect to the part 106 while the energy sources 904 may be moving or may be stationary with respect to the part 106. Other components may be used to then direct the energy beams if the energy sources are also stationary. In one embodiment, if the energy sources are lasers, movement of the laser beam energy sources may be accomplished by, but not limited to, a galvanometer or a moving reflector. As with previous embodiments, as the particle stream passes through the sound field, characteristics of the particle stream are controlled by the sound field to, for example, spatially modify the particle stream to have a desired cross-sectional area and/or shape before reaching the melt pools 116.

In one application of the current embodiment, the sound field may be designed so that the particle stream follows a specific path from the material nozzle 902 to the part 106.

In another application of the current embodiment, the sound field may be designed such that the material nozzles 902 can have different powder sources with different material compositions, and the powder streams can be quickly changed to switch the material going to one of the melt pools 116, to allow for the fabrication of functionally graded materials.

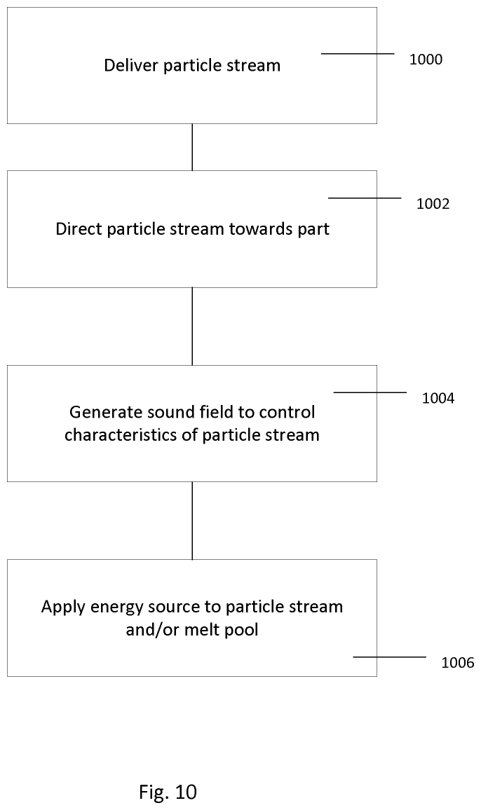

Turning to FIG. 10, a flowchart outlining a method of directed energy deposition is shown. Initially, a particle stream is delivered to a particle stream nozzle (1000) such as from a material feed system. In one embodiment, the material system uses, but is not limited to, gas or gravity or both to move the material from the feed system through the nozzle towards the part being fabricated or repaired. The nozzle then directs the particle stream towards the part that is being build or repaired (1002). As the particle stream travels towards the part, a sound field is generated (1004) that the particle stream passes through. The sound field controls or changes the characteristics of the particle stream before it comes into contact with the part. Characteristics of the particle stream that may be changed include, but are not limited to, the cross-section of the particle stream, particles' speed, the path of the particle stream, the shape of the particle stream.

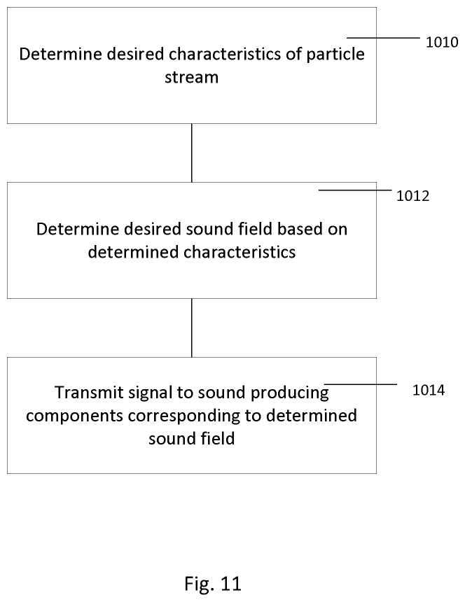

One embodiment of generating a sound field is shown in FIG. 11. Initially, a determination of the desired characteristics of the particle stream is performed (1100). For example, this may include determining the desired cross-section of the particle stream, determining a path of the particle stream, determining a position on the plate where it is desired that the particle stream contact. Once the desired characteristics are determined, a calculation of the desired sound field characteristics is then performed (1102). This may be performed either using analytic solutions such as for generating a sound vortex field with different topological charges (analytic phase hologram solutions), numerical optimization of the signal amplitude and/or phases used for the sound sources or iterative backpropagation (as taught above). It is understood that other methodologies are contemplated. The desired sound field characteristics may be in the form of signals to be transmitted to the sound sources to generate the desired sound field. The system then transmits the signals to the sound sources to generate the desired sound field (1104).

Turning back to FIG. 10, an energy source is then applied to the particle stream to generate a melt pool as the particle stream contacts the part (1006). In some embodiments, the sound field may be generated and/or applied to the particle stream at the same time as the energy beam interacts with the particle stream. As such, different energy/particle stream arrangements with respect to the application of the sound field will produce different particle-energy-sound force field interactions. For example, if the sound is applied before the energy source melts the particle stream, the resulting characteristics of the powder stream are different than if the sound field is applied at the same time the energy source melts the particle stream. Also, as there may be environmental changes, which may cause reflections and refractions of the sound field, there may be regular re-calculations of the sound field and the sound field may be dynamically updated as the directed energy deposition is happening.

During experiments, a relationship to determine or calculate a particle stream deflection angle was derived using the following assumptions: (1) the force towards the sound field axis crossing the sound focus point decreases linearly to zero; which is an appropriate assumption if a vortex sound field is being used and the approximate cross-sectional radius of the particle stream is less than a quarter of the sound wavelength; and (2) the carrier gas and the particles have a low relative velocity, i.e. negligible particle gas drag.

The derived relationship indicates that the degree of deflection and focusing is higher if the particles in the particle stream are moving slower and/or are less dense. Also, the approximate particle displacement for equally dense particles and for a wide particle size range is independent of particle size, meaning a high degree of focusing is possible even if using a powder with a wide particle size distribution. Other methods such as electromagnetic particle deflection have a dependence on the particle size. Another relation that was realized was the focal length of the particle stream, i.e. at what distance do the particles reach the particle stream axis. From this relation it was found that the focal length is very weakly dependent on the particle's initial normal offset from the particle stream axis (if assumption one is applicable), meaning all the particles have approximately a common focal point such as in an optical or electron lens.

In an alternative embodiment, where the energy source is a laser, the laser energy beam should provide a local addition of power to the material being added to the part being fabricated. In order to control this additional power, the laser beam may be moved and rotated in space using a galvanometer or by moving the energy source via the robotic arm such as schematically shown in FIG. 5. Energy beams may also be moved, or re-directed, by other suitable methods such as, but not limited to, electromagnets for charged-particle energy beams.

In one embodiment, although the system is able to operate by using sound source input signals ignoring reflections and/or refractions from the part and/or system enclosure, a fewer number of sound sources and/or a reduction of their power consumption might be achievable if the signals going to the sound sources i.e. the required phases are calculated taking into account these reflections and/or refractions. This may be calculated (when the desired sound field is calculated) for reflections either taking one sound reflection instance into account or taking into account an infinite number of sound reflections. An infinite amount of reflections does not happen physically but this assumption simplifies the calculation while being able to more accurately approximate a large number of reflections which is closer to what is happening physically.

A calculation method to find the required signals taking one sound reflection into account can be carried out by combining a modified matrix method with the Gor′kov potential equation to simulate the pressure and potential field generated by all the sound sources. In the traditional matrix method, the radiation surface of each transducer is discretized in small surface elements. For this calculation method an analytical expression for the acoustic pressure generated by the sound sources using the far-field approximation may be used. This modified matrix method may be used to calculate more than one reflection however it may be very computationally expensive. An example of the calculation taking into account one reflection being used for transporting and merging liquid dropplets in mid-air is described in M. A. B. Andrade, T. S. A. Camargo, and A. Marzo, “Automatic contactless injection, transportation, merging, and ejection of droplets with a multifocal point acoustic levitator,” Review of Scientific Instruments, vol. 89, no. 12, p. 125105, December 2018, doi: 10.1063/1.5063715.

A calculation method to find the required signals taking an infinite amount of reflections into account can be carried out by simulating the sound field using the boundary element method for solving the Helmholtz equation and directly solving a constrained optimization problem to obtain the required phases. This can be shown to reduce to an eigendecomposition. An example of the calculation taking into account an infinite number of reflections for ultrasound directed self-assembly to organize particles dispersed in a fluid medium into a desired three-dimensional user-specified pattern is described in M. Prisbrey, J. Greenhall, F. Guevara Vasquez, and B. Raeymaekers, “Ultrasound directed self-assembly of three-dimensional user-specified patterns of particles in a fluid medium,” Journal of Applied Physics, vol. 121, no. 1, p. 014302, January 2017, doi: 10.1063/1.4973190.

Although the latter method is more accurate, it may be more computationally expensive. An even fewer number of sound sources or sound source power consumption may be achieved if this calculation is done taking into account the varying shape of the part while being manufactured and taking into account sound field modification components.

The operation of the system at very high sound intensities may produce observable distortions in the sound field due to non-linear sound propagation. These effects might be reduced either by using a certain gas at some temperature and pressure surrounding the directed energy deposition process and/or taking into account the physics of non-linear sound propagation when calculating the signals going to the sound sources.

The greater degree of freedom due to changing the degree of particle focusing independent of distance from the nozzle to the part allows for the possibility of a better cross-sectional particle concentration distribution at the particle stream for different melt pool sizes. This may be used together with the use of multiple energy beams that can rotate independently and/or have variable power output and focal lengths to produce a directed energy deposition system that can print at different resolutions while the part is being fabricated or repaired. By printing at finer voxel resolutions at the surface of the part and coarser voxel resolutions otherwise may also increase the system's part throughput. This print speed increase for the same surface resolution has been observed when the same variable voxel resolution is available in the two-photon polymerization additive manufacturing process. One example of this is shown in Y. Tan et al., “High-throughput multi-resolution three dimensional laser printing,” Phys. Scr., vol. 94, no. 1, p. 015501, November 2018, doi: 10.1088/1402-4896/aaec99.

In one embodiment, for the gas system that transports the material from the material feed system to and through the nozzle towards the part, the gas may be an Ar—He gas mix that can closely match air's acoustic impedance. Alternatively, the gas may be neon or any other gases whereby the gas or gas mixture closely matches the acoustic impedance of air. In another embodiment, the gas may be nitrogen. In a further embodiment, the system may include a transducer that can interact with the gas system to improve power transfer based on the gas and a required wavelength to better affect the particle stream. The presence of the transducers may facilitate calculation of the sound field to be generated based on parameters such as, but not limited to, orientation of transducers, location of transducers, density of gas, density of metal, speed of sound in both, frequency of sound and sound pressure field around transducer for a specific applied voltage.

Affecting the path of the particle stream in either of the systems shown in FIG. 1 or 9 may be achieved by considering the superposition of multiple sound fields, the multiple sound fields each having a sound focus point located on a curve going from the material nozzle to the melt pool (or where the material comes into contact with the part). The multiple sound fields may be used to steer the particle stream such that it follows a similar path as the curve. In one embodiment, the required sound fields may be calculated using the iterative backpropagation methodology to find the phases of the sound sources.

In a further embodiment, the particle stream gas and shielding gas may be accelerated and/or directed via acoustic streaming phenomenon, where the sound field used to affect the particles in the particle stream, another sound field, or rapidly switching between the sound field used to affect the particles in the particle stream and another sound field may be used to also move a gas. A sound field that may be used for this may be an acoustic Bessel beam. An example where an acoustic Bessel beam generated from a phased array (multiple sound sources) is used to produce an electronically steerable long narrow air stream is described in K. Hasegawa, L. Qiu, A. Noda, S. Inoue, and H. Shinoda, “Electronically steerable ultrasound-driven long narrow air stream,” Appl. Phys. Lett., vol. 111, no. 6, p. 064104, August 2017, doi: 10.1063/1.4985159. Other sound fields besides an acoustic Bessel beam for more complex gas stream paths may also be used.

Thus, through experiments and/or simulations, it was shown that that the use of a sound field can be used to change the powder stream cross-sectional size and shape (spatial focusing) in order to produce a metal component at a faster rate and a higher resolution.

Faster part manufacture may be possible by quickly changing the powder stream cross-sectional size (degree of powder focusing) for many possible feature sizes and surface resolutions. The degree of focusing may be higher than a typical directed energy deposition nozzle for a wider range of particle mass feed rates. Fast changes in the degree of focusing may also allow for a more accurate material deposition when using different materials in the same part, which might produce different particle stream shapes when going through the same nozzle in a typical directed energy deposition machine. Switching materials while producing the same part is required to produce parts with functionally graded materials for example.

Doing this in a typical directed energy machine would require stopping the fabrication process many times while making a single component and switching between many different nozzles. The method herein may be considered solid-state, which may allow for higher reliability as well as faster part manufacture. Both the change of the powder stream cross-sectional size and shape may allow for the real-time feedback needed to control melt pool track geometry, microstructure properties such as metal grain morphology and phase formation, as well as controlling against porosity formation for example.

The method herein uses sound fields to affect the particle stream and does not use sound fields to affect the spatial location and orientation of the part being built. Using sound fields to move and rotate the part while it is being built would require a continuous accurate simulation and modification of the required sound field to account for the changing shape of the part and the recoil from the impacting particles for accurate material deposition.

Another advantage of the current disclosure is that the method and system of the disclosure uses sound to deflect the particle streams and does not require a given amount of particles to reach and/or levitate at the node at a particular spatial location in a standing wave field. This increases the density range of particles that may be used with this method i.e. full metal particles may be used instead of only metal-containing particles. Also, the sound field may or may not be a standing wave-field between at least one set of opposing sound sources (transducers). The method herein also may use a sound field with the highest sound period averaged pressure intensity volume away from the part being built, with the final smallest particle stream cross-sectional area being produced downstream of this volume. This is due to the particles being deflected and then focusing further due to their own inertia as illustrated for example in FIG. 4. As such, the method and system of the disclosure may be less susceptible to sound reflections and refractions from the part, which may apply to other methods that may require a high or the highest sound period averaged pressure intensity volume to be placed closer to the part. This issue may be alleviated by the calculation methods for the signals going to the sound sources taking into account the part geometry described before, however, the fidelity of the simulation and its related computation time will be higher since these effects need to be modeled more accurately.

In an alternative embodiment, the directed energy deposition system and method of the disclosure may be able to produce parts with functionally graded materials, by gradually changing from one material source to another while the nozzle is depositing material during the manufacture of a single part. This may be very useful in the aircraft and aerospace industries as well as the computer circuit industries, which require parts to withstand high-temperature gradients. An effective way of achieving this is with a functionally graded material composed of a ceramic and a metal for example.

In a further embodiment, the system and method of the disclosure may benefit from additional build control mechanisms to achieve particle focusing independently of the gas moving the particles from the feed system to and through the nozzle and the shielding gas, to control the distance and direction of the produced particle focus point and to change the cross-sectional size and shape of the particle stream at the particle focus point while the component is being manufactured.

In another embodiment, the system may be able to perform variable resolution printing. In this embodiment, the energy source may be a laser where the laser focus is adjustable so that the laser spot diameter can be changed, such as via, but not limited to, a liquid crystal lens. Other mechanical methods of manipulating the laser spot diameter are also contemplated.

In a further embodiment, the system may include a vision system, such as a camera vision system for more accurately aligning the energy beam and the powder stream, using the sound field to affect the powder or particle stream. The camera vision system may also be used to monitor the powder stream to provide feedback to the system whereby the sound focus point can be dynamically changed/updated by the system to adjust for unexpected variances.

In another embodiment, the system may optimize, or improve, both phase and voltage for vortex like fields with a force function normal to the particle stream axis, producing a different effective ‘lens’ diameters (similar to a vortex field) regardless of transducer produced sound wavelength. Furthermore, with a pulse width modulation (motor control) type of system, as described in FIG. 8b, by switching between a vortex sound and a twin sound field, the cross sectional area of the powder stream may be made into a rotated ellipse (the rotation angle can be adjusted and corresponds to the twin field angle) when close to the center of the field.

The above-described embodiments of the disclosure are intended to be examples of the present disclosure and alterations and modifications may be effected thereto, by those of skill in the art, without departing from the scope of the disclosure.

In this description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. Further, elements of an embodiment may be used with other embodiments and/or substituted with elements from another embodiment as would be understood by one of skill in the art.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

1. A method of directed energy deposition comprising:
generating a sound field;
passing a particle stream through or by the sound field towards a part being fabricated; and melting the particle stream as it contacts the part being fabricated;
wherein the sound field controls at least one characteristic of the particle stream as it passes through the sound field and contacts the part being fabricated.

2. The method of claim 1 further comprising, before generating a sound field:
generating the particle stream.

3. The method of claim 2 wherein generating the particle stream comprises:
transporting material from a material feed system to a material nozzle; and
directing the material into the particle stream towards the part being fabricated.

4. The method of claim 3 wherein transporting material from the material feed system to the material nozzle is via a pressurized gas system.

5. The method of claim 1 wherein generating a sound field comprises:
determining desired characteristics of the particle stream;
calculating the sound field required to achieve the desired characteristics; and
transmitting signals to sound sources to generate the sound field.

6. The method of claim 5 wherein calculating the sound field comprises:
calculating the sound field using an iterative backpropagation methodology, analytic phase hologram solutions or numerical optimization of signal amplitude and/or phases of sound sources.

7. The method of claim 6 wherein calculating the sound field using an iterative backpropagation methodology comprises:
calculating the sound field using a Gor′kov methodology.

8. The method of claim 1 wherein generating the sound field comprises:
generating at least one sound period averaged pressure intensity isosurface.

9. The method of claim 1 further comprising:
coating the particle stream with a gaseous or liquid medium before passing the particle stream through of by the sound field.

10. The method of claim 1 wherein the at least one characteristic comprises a particle stream cross-sectional particle concentration distribution; a cross-sectional size of the particle stream; a shape of the particle stream or a path of the particle stream.

11. A system for directed energy deposition comprising:
at least one nozzle for directing a particle stream at a part;
at least one energy source for melting the particle stream; and
at least one sound source for generating a sound field which the particle stream passes through, the sound field controlling characteristics of the particle stream before it contacts the part.

12. The system of claim 11 further comprising:
a processor for calculating and generating the sound field.

13. The system of claim 11 further comprising:
at least one sound field modification component for generating the sound field.

14. The system of claim 11 further comprising a material feed system for supplying material, in the form of the particle stream, to and through the at least one nozzle.

15. The system of claim 14 wherein the material may be one of a metal, a metal alloy, a metal filler, a metal-containing flux material, a dopant, a ceramic, a composite, a polymer or any combination thereof.

16. The method of claim 1 wherein generating a sound field comprises:
generating isosurfaces for controlling the particle stream as the particle stream passes through or by the isosurfaces.

17. The method of claim 1 wherein the sound field further controls material properties of the part being fabricated.

18. The method of claim 17 wherein the sound field controls material properties of the part being fabricated by controlling a shape of a melt pool of the part being fabricated.
